(19) United States
(12) Patent Application Publication
(10) Pub. No.: US 2008/0305370 A1
(43) Pub. Date: Dec. 11, 2008

(54) FUEL CELL SYSTEM AND METHOD OF OPERATING A FUEL CELL

(75) Inventors: Dieter Melzner, Goettingen (DE); Annette Reiche, Goettingen (DE); Stefan Haufe, Goettingen (DE)

Correspondence Address: SUGHRUE MION, PLLC, 2100 PENNSYLVANIA AVENUE, N.W., SUITE 800, WASHINGTON, DC, 20037, US

(73) Assignee: SARTORIUS STEDIM BIOTECH GmbH, Goettingen (DE)

(21) Appl. No.: 12/047,377

(22) Filed: Mar. 13, 2008

Related U.S. Application Data
(63) Continuation of application No. PCT/EP2006/008051, filed on Aug. 16, 2006.

(30) Foreign Application Priority Data
Sep. 20, 2005 (DE) DE102005044825.9

(51) Int. Cl. H01M 8/00; H01M 8/04

(52) U.S. Cl. 429/13; 429/24

(57) ABSTRACT

The invention provides an improved fuel cell system and a method of operating a fuel cell, which ensure that the fuel cell can be operated at high efficiency without irreversible damage. The fuel cell system according to the invention has at least one fuel cell with a fuel cell stack and with separator plates, which are equipped with inlets and outlets for a heat transfer medium, a thermostat, a heat transfer medium circuit, which has a transport device for the heat transfer medium and includes at least the fuel cell and the thermostat, at least one temperature sensor for the fuel cell and a monitoring and control unit for the temperature of the fuel cell. With the invention it is possible to operate the fuel cell in a range close to the preset optimum operating temperature.

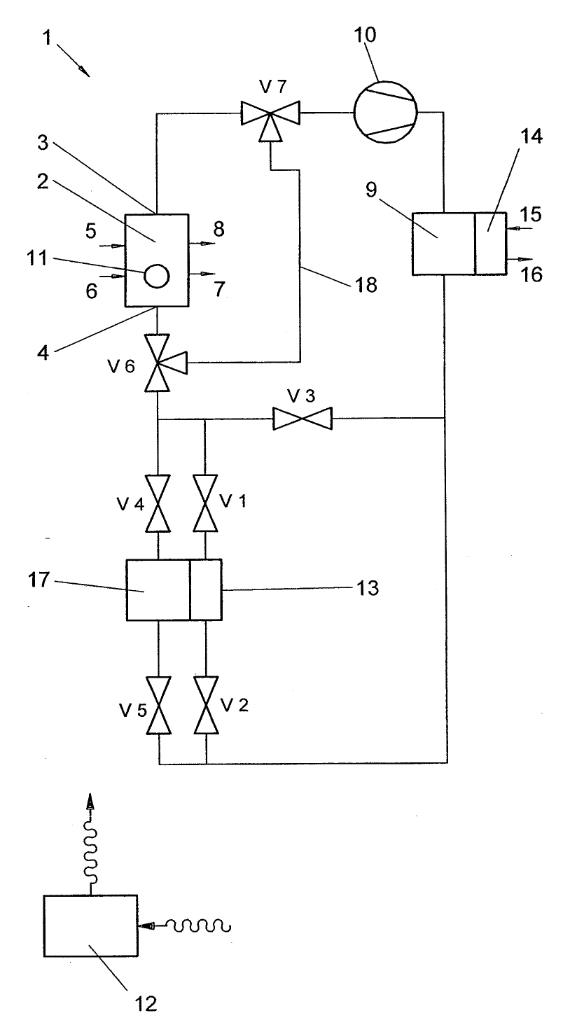

This is a Continuation of International Application PCT/EP2006/008051, with an international filing date of Aug. 16, 2006, which was published under PCT Article 21(2) in German, and the complete disclosure of which is incorporated into this application by reference.

### FIELD AND BACKGROUND OF THE INVENTION

The invention relates to an improved fuel cell system and a method of operating a fuel cell within an optimum temperature range.

To achieve high efficiency of fuel cells, the fuel cells must be operated at an optimum operating temperature. This is particularly true for high-temperature fuel cells or high-temperature polymer electrolyte membrane fuel cells (HT-PEM fuel cells). Such HT-PEM fuel cells, which are equipped with polybenzimidazole-based proton-conducting polymer electrolyte membranes, for example, can be operated at temperatures of up to 250° C. High efficiency is said to be present if a maximum amount of electric power is generated from a given amount of fuel at the same electrical efficiency. The optimum operating temperature for HT-PEM fuel cells ranges between approximately 110° and approximately 230° C. Its value is determined experimentally and depends on a number of factors, such as the design of the fuel cell system (for example, polymer membrane material, temperature behavior of the dopant, allowable pressure), the type of the heat transfer medium or the purity of the fuel. If a liquid heat transfer medium is used, the optimum operating temperature should be below the boiling point of the heat transfer medium. If water is used as the heat transfer medium, the resulting optimum operating temperature within the heat transfer medium circuit of the fuel cell system would be less than 120° C. at a pressure of 1.987 bar absolute, 140° C. at a pressure of 3.615 bar absolute or 160° C. at a pressure of 6.181 bar absolute. To limit the complexity of the seals on the fuel cell and within the fuel cell system if water is used as the heat transfer medium, the optimum operating temperature to be strived for is less than 140° C. If silicon oils or mineral oils are used as the heat transfer medium, the optimum operating temperature can be above 200° C. even below atmospheric pressure, for example. If hydrogen contaminated with carbon monoxide, for example, is converted rather than pure fuel, the fuel cell system is all the more tolerant of this contamination the higher the operating temperature is selected, so that in this case the optimum operating temperature is set as high as possible. The preset optimum operating temperature in tenns of the invention takes into account an upper temperature difference of approximately 20% as a temperature buffer to ensure that there is no damage to material during operation at the extreme range of these temperatures.

Lowering the cell voltage causes fuel cells to generate more electric power, which is associated with an increased supply of fuel and/or oxidant. Because this causes more heat to be released, the temperature of the fuel cell can increase to such an extent that the range of its optimum operating temperature is exceeded and additional damage to its components may occur. Increasing the cell voltage causes fuel cells to generate less electric power, which is associated with a decreased supply of fuel and/or oxidant. Because this causes less heat to be released, the temperature of the fuel cell can drop below the range of its optimum operating temperature, which leads to a loss of power of the fuel cell, due, for example, to an increased internal resistance of the fuel cell-due in part to membrane resistance and overvoltages at the electrodes. Under these circumstances it is no longer possible to operate the fuel cell economically.

Various fuel cell systems and methods of operating fuel cells in certain temperature ranges are known in the art. WO 2004/036675 A2 describes a method of controlling a fuel cell system in which a desired temperature of the fuel cell is to be maintained. To this end, the fuel cell system has means for regulating the temperature of a coolant circulated through the fuel cell. Excess heat is withdrawn from the coolant by heating water in a water tank to moisten gases supplied to the anode and/or cathode side of the fuel cell and/or by a radiator. In the startup phase of the fuel cell, the coolant can be heated by a heating device. In the heating device the fuel is catalytically converted.

U.S. Pat. No. 6,649,290 B2 describes a method in which a preferred working temperature is maintained for various components of a fuel cell apparatus, including the fuel cell itself, by guiding adjustable streams of a coolant gas across a specifically selected arrangement of the components.

According to U.S. Pat. No. 6,682,836 B2, a temperature interval at which the temperature is sufficiently high to ensure an efficient process and sufficiently low with respect to the employed materials is maintained within the fuel cell by regulating the oxidant stream.

According to U.S. Pat. No. 6,635,375 B1, air and fuel are preheated for optimum operation of a solid oxide fuel cell, and the temperatures and the quantities of the supplied gas are adjusted in a control circuit.

German publication DE 103 60 458 A1 describes a fuel cell system with a burner that can optionally be operated with fuel and/or fuel cell exhaust gas. A heat exchange arrangement is provided to transfer the heat produced in the burner to the air to be supplied to the fuel cell and/or the hydrogen-containing gas to be supplied to the fuel cell.

European publication EP 1 507 302 A2 describes a fuel cell cascade (solid oxide fuel cell), in which a small fuel cell unit maintains its operation while a large fuel cell unit is out of operation. If a higher power output is required, the steam generated in the small unit is used to heat the large unit.

According to Gennan publication DE 102 32 870 A1, only a partial area of the cell is supplied to start up a fuel cell until this area has heated the adjacent areas to the startup temperature. Bipolar plates are configured accordingly for this purpose.

German publication DE 103 37 898 A1 proposes to supply excess heat to a latent heat storage device during normal operation of a fuel cell and to use this heat during the startup phase.

A drawback of the described fuel cell systems is that the fuel cells are not consistently operated within a narrow optimum operating temperature range of the fuel cell, so that their efficiency is inadequately utilized.

### OBJECT OF THE INVENTION

It is therefore an object of the invention to provide an improved fuel cell system and a method of operating a fuel cell to ensure that the fuel cell can be operated at high efficiency without irreversible damage.

### SUMMARY OF THE INVENTION

This object is achieved by a fuel cell system that includes at least one fuel cell with a fuel cell stack and separator plates, which are equipped with inlets and outlets for a heat transfer medium, a thermostat, a heat transfer medium circuit, which has a transport device for the heat transfer medium and includes at least the fuel cell and the thermostat, at least one temperature sensor for the fuel cell and a monitoring and control unit for the temperature. Surprisingly it has been found that by combining these parts of the fuel cell system by means of the monitoring and control unit and the temperature sensor of the fuel cell, the temperature of the fuel cell can be regulated such that after the startup phase the operating temperature falls below a preset optimum operating temperature by no more than 5% and exceeds it by no more than 20%. The fuel cell system is preferably designed such that the operating temperature falls below the preset optimum operating temperature by no more than 3% and exceeds it by no more than 10% and, particularly preferably, falls below it by no more than 2% and exceeds it by no more than 5%. This can be achieved through the heat transfer medium type used, the configuration of the separator plates, the thermostat and/or the transport device and/or through the method of operating the fuel cell. Pumps or radiators are used as transport devices. The at least one temperature sensor of the fuel cell is arranged on, or in, the fuel cell.

In a preferred embodiment of the invention, the at least one temperature sensor is arranged in the fuel cell stack of the fuel cell. The at least one temperature sensor can be installed directly in the membrane electrode unit, for example. These arrangements ensure that the fuel cell temperature is measured without delay, directly at the point where the heat is primarily generated in the fuel cell. Time lags in temperature measurement caused by heat conduction are thereby excluded.

In another embodiment of the invention, a heat accumulator is connected to the heat transfer medium circuit to supply or discharge heat energy to or from the heat transfer medium. With the heat accumulator, a higher variability of the fuel cell system is achieved and heat peaks or heat deficits can be equalized. Media with a high specific heat or latent heat storage devices are preferred as heat accumulators. The excess-heat or heat-deficit equalization effects can also be amplified by installing a heat exchanger connected to the thermostat to supply or discharge heat energy to or from the thermostat.

Preferred heat transfer media are liquid media, such as water, silicon oils or mineral oils.

Another improved embodiment of the invention consists in connecting a buffer vessel with an additional heat transfer medium quantity to the heat transfer medium circuit of the fuel cell system to supply or discharge heat energy to or from the fuel cell.

A further object of the invention is achieved by a method of operating a fuel cell in a fuel cell system, which includes the following steps:

A) Circulating a heat transfer medium in a heat transfer medium circuit, which includes at least one fuel cell with separator plates equipped to supply and discharge the heat transfer medium, a thermostat and a transport device for the heat transfer medium,
B) Modifying the supply of fuel and/or oxidant to the fuel cell as a function of the quantity of electricity to be generated,
C) Measuring the temperature of the fuel cell,
D) Comparing the temperature measured in step C) with a preset optimum operating temperature of the fuel cell of the fuel cell system,
E) If the comparison of step D) shows that the measured temperature differs from the preset optimum operating temperature of the fuel cell, changing the working temperature of the heat transfer medium and/or changing the heat transfer medium flow rate through the fuel cell by means of the transport device in magnitudes which allow the temperature of the fuel cell to fall below the preset optimum operating temperature of the fuel cell system by no more than 5% and to exceed it by no more than 20% after the startup phase.

Preferably, step E) is executed in such a way that the operating temperature falls below the preset optimum operating temperature by no more than 3% and exceeds it by no more than 10% and, particularly preferably, falls below it by no more than 2% and exceeds it by no more than 5%.

In a preferred embodiment of the method, a heat accumulator is additionally connected to the heat transfer medium circuit according to step A) to supply or discharge heat energy to or from the heat transfer medium.

In another embodiment of the method according to the invention, the thermostat is connected to a heat exchanger to supply or discharge heat energy to or from the thermostat.

In this method, the preferred heat transfer medium circulated through the heat transfer medium circuit is a liquid medium, particularly water, silicon oils or mineral oils.

In another embodiment of the invention, a buffer vessel with an additional heat transfer quantity is connected to the heat transfer medium circuit to supply or discharge heat energy to or from the fuel cell. This ensures that, for example, when power demand is low, the fuel cell can be supplied with an adequate quantity of heat to avoid exceeding the threshold values below and above the preset optimum operating temperature in accordance with step E).

In another embodiment of the method according to the invention, the temperature in the fuel cell is measured according to step C) at least one point in the fuel cell stack itself. For this purpose, the at least one temperature sensor is installed directly in the separator plates or directly in the membrane electrode unit, for example. The method according to the invention is preferably carried out automatically using a monitoring and control unit.

### BRIEF DESCRIPTION OF THE DRAWINGS

The invention will now be described in greater detail with reference to the FIGURE and the exemplary embodiments.

The FIGURE is a schematic diagram of a fuel cell system according to the invention.

### DETAILED DESCRIPTION OF THE PREFERRED EMBODIMENTS

The FIGURE shows a fuel cell system 1, including a fuel cell 2 with a fuel cell stack (not depicted) and separator plates (not depicted), which are provided with inlets 3 and outlets 4 for a heat transfer medium. The fuel cell 2 further has inlets for a fuel 5 and an oxidant 6 and outlets for oxidation products 7 and non-converted fuels 8. The fuel cell system 1 further includes a thermostat 9, a heat circuit with a transport device 10 for the heat transfer medium and at least one temperature sensor 11 for the fuel cell 2. A monitoring and control unit 12 is connected to the at least one temperature sensor 11, the pump 10 and valves V1 to V7. (The connections are not depicted.) A heat accumulator 13 can be connected to the heat transfer medium circuit through valves V1 and V2. The thermostat 9 is moreover connected to a heat exchanger 14 to supply 15 or discharge 16 heat energy to or from the thermostat. The FIGURE further shows a buffer vessel 17, which is provided with an additional amount of heat transfer medium to supply or discharge heat energy to or from the fuel cell 2 and which can be connected to the heat transfer medium circuit through valves V4 and V5. The fuel cell 2 is provided with a bypass line 18 and can be disconnected from the heat transfer medium circuit using valves V6 and V7. This makes it possible to first heat the heat transfer medium circuit with the optionally added components 9, 13, 14, 17 before starting up the cold fuel cell 2, such that after the fuel cell 2 is connected it can be rapidly heated to the preset optimum operating temperature.

To operate the fuel cell 2 of the fuel cell system 1, a heat transfer medium is circulated through the heat transfer medium circuit with open valve V3 and a corresponding position of valves V6 and V7 (three-way valves) after the startup phase. The heat transfer medium circuit includes at least the fuel cell 2, the thermostat 9 and the transport device 10 for the heat transfer medium (step A). If it is determined, based on the quantity of electricity to be generated, the measured temperature (steps B and C) and the comparison of the temperature measured in C) with a preset optimum operating temperature of the fuel cell (step D), that more heat must be discharged from the fuel cell 2 or supplied to the fuel cell 2 to maintain the allowable temperature deviation, the delivery rate of the transport device 10 can initially be decreased or increased and/or the buffer vessel 17 can be connected to the heat transfer medium circuit via valves V4 and V5 with valves V1 through V3 closed. For special peaks, the heat accumulator 13 is connected through valves V1 and V2 with valve V3 closed, so that it can absorb heat peaks or discharge heat energy into the heat transfer medium circuit when it is charged with heat. In addition, external heat energy can be supplied 15 to the fuel cell system or excess heat energy can be discharged 16 from the fuel cell system through the heat exchanger 14 when all the components 9, 17, 13 of the heat transfer medium circuit are charged with heat energy.

### Example 1

The optimum operating temperature of a fuel cell system according to the invention for mobile applications that is operated with pure hydrogen was determined to be 120° C. The HT-PEM fuel cell has a phosphoric acid-doped polybenzimidazole membrane. The heat transfer medium circuit can be operated with water up to a pressure of 3.615 bar absolute. If the quantity of electricity obtained at this temperature from a normalized quantity of consumed hydrogen at the same electric efficiency is set equal to 100%, then the quantity of electricity generated at 145° C. from the normalized quantity of hydrogen was 106%, and the quantity of electricity generated at 103° C. from the normalized quantity of hydrogen was 89%. No damage to material was observed.

### Example 2

The optimum operating temperature of a fuel cell system according to the invention for stationary applications that is operated with a hydrogen mixture generated by a reformer (share of carbon monoxide 0.33% by volume) was determined to be 160° C. The same fuel cell as in example 1 was used. However, the fuel cell system was operated with mineral oil as the heat transfer medium, instead of water, at slightly above 1 bar absolute. The mineral oil is stable in long-term use up to above 250° C.

If the quantity of electricity obtained at the preset optimum operating temperature of 160° C. from a normalized quantity of consumed hydrogen at the same electrical efficiency is set equal to 100%, then the quantity of electricity generated at 185° C. from the normalized quantity of hydrogen was 110%, and the quantity of electricity generated at 155° C. from the normalized quantity of hydrogen was 94%. No damage to material was observed.

The above description of the preferred embodiments has been given by way of example. These and other features of preferred embodiments of the invention are described in the claims as well as in the specification and the drawings. The individual features may be implemented either alone or in combination as embodiments of the invention, or may be implemented in other fields of application. Further, they may represent advantageous embodiments that are protectable in their own right, for which protection is claimed in the application as filed or for which protection will be claimed during pendency of this application or an application claiming benefit thereto. From the disclosure given, those skilled in the art will not only understand the present invention and its attendant advantages, but will also find apparent various changes and modifications to the structures and methods disclosed. The applicant seeks, therefore, to cover all such changes and modifications as fall within the spirit and scope of the invention, as defined by the appended claims, and equivalents thereof.

What is claimed is:

1. A fuel cell system, comprising at least:
a fuel cell with a fuel cell stack and with separator plates, which are provided with inlets and outlets for a heat transfer medium,
a thermostat,
a heat transfer medium circuit having a transport device for the heat transfer medium and including at least the fuel cell and the thermostat,
at least one temperature sensor for the fuel cell, and
a monitoring and control unit for the temperature, such that the temperature of the fuel cell falls below a preset optimum operating temperature by no more than 5% and exceeds it by no more than 20% after the startup phase.

2. A fuel cell system as claimed in claim 1, characterized in that
the at least one temperature sensor measures the temperature of the fuel cell stack, wherein the temperature sensor is arranged in, or on, the fuel cell stack.

3. A fuel cell system as claimed in claim 1, comprising:
a heat accumulator connectable to the heat transfer medium circuit to supply or discharge heat energy to or from the heat transfer medium.

4. A fuel cell system as claimed in claim 1, comprising
a heat exchanger connected to the thermostat to supply or discharge heat energy to or from the thermostat.

5. A fuel cell system as claimed in claim 1, characterized in that
the heat transfer medium is a liquid medium.

6. A fuel cell system as claimed in claim 5, comprising:
a buffer vessel, which is connectable to the heat transfer medium circuit and has an additional quantity of heat transfer medium to supply or discharge heat energy to or from the fuel cell.

7. A method of operating a fuel cell in a fuel cell system comprising the steps:
A) circulating a heat transfer medium in a heat transfer medium circuit, which comprises at least one fuel cell with separator plates equipped to supply and discharge the heat transfer medium, a thermostat and a transport device for the heat transfer medium,
B) modifying the supply of fuel and/or oxidant to the fuel cell as a function of the quantity of electricity to be generated,
C) measuring the temperature of the fuel cell,
D) comparing the temperature measured in step C) with a preset optimum operating temperature of the fuel cell of the fuel cell system,
E) if the comparison of step D) shows that the measured temperature differs from the preset optimum operating temperature of the fuel cell, changing the working temperature of the heat transfer medium and/or changing the heat transfer medium flow rate through the fuel cell by means of the transport device in magnitudes which allow the temperature of the fuel cell to fall below the preset optimum operating temperature of the fuel cell system by no more than 5% and to exceed it by no more than 20% after the startup phase.

8. A method of operating a fuel cell as claimed in claim 7, characterized in that
a heat accumulator is additionally connected to the heat transfer medium circuit in accordance with step A) to supply or discharge heat energy to or from the heat transfer medium.

9. A method of operating a fuel cell as claimed in claim 7, characterized in that
the thermostat is connected to a heat exchanger to supply or discharge heat energy to or from the thermostat.

10. A method of operating a fuel cell as claimed in claim 7, characterized in that
a liquid medium is used as the heat transfer medium circulating through the heat transfer medium circuit.

11. A method of operating a fuel cell as claimed in claim 10, characterized in that
a buffer vessel with an additional quantity of heat transfer medium is connected to the heat transfer medium circuit to supply or discharge heat energy to or from the fuel cell.

12. A method of operating a fuel cell as claimed in claim 7, characterized in that
the temperature in the fuel cell is measured according to step C) at least one point in the fuel cell stack.

13. A method of operating a fuel cell as claimed in claim 7, characterized in that
the method is carried out automatically by means of a monitoring and control unit.
